(19) United States
(12) Patent Application Publication
(10) Pub. No.: US 2018/0051199 A1
(43) Pub. Date: Feb. 22, 2018

(54) HEAT-CONDUCTIVE SILICONE RESIN COMPOSITION AND CURING METHOD

(71) Applicant: Shin-Etsu Chemical Co., Ltd., Tokyo (JP)

(72) Inventor: Kenichi INAFUKU, Annaka-shi (JP)

(73) Assignee: Shin-Etsu Chemical Co., Ltd., Tokyo (JP)

(21) Appl. No.: 15/644,365

(22) Filed: Jul. 7, 2017

(30) Foreign Application Priority Data
Aug. 16, 2016 (JP) 2016-159492

(51) Int. Cl. C09K 5/14; C08L 83/04

(52) U.S. Cl. CPC C09K 5/14; C08L 2203/20; C08L 2205/02; C08L 83/04

(57) ABSTRACT

A heat-conductive silicone resin composition is provided comprising (A) an alkenyl-containing organopolysiloxane, (B) a SiH-containing organohydrogenpolysiloxane, (C) a heat-conductive filler, (D) a platinum group metal based catalyst, and (E) a thiol or sulfide group-containing organic compound. The composition has a cure onset time at 150° C. of from 10 minutes to less than 30 minutes, as measured by a scanning vibrating needle curemeter. The invention is effective for substantially suppressing unintended thickening or curing during the semiconductor device fabrication process even at a temperature of 150° C. or higher, but the composition is still curable in the desired shape.

### CROSS-REFERENCE TO RELATED APPLICATION

This non-provisional application claims priority under 35 U.S.C. §119(a) on Patent Application No. 2016-159492 filed in Japan on Aug. 16, 2016, the entire contents of which are hereby incorporated by reference.

### TECHNICAL FIELD

This invention relates to a heat-conductive silicone resin composition which is suited as a heat-dissipating material for various electronic parts. More particularly, it relates to a heat-conductive silicone resin composition which has an adequate pot life at high temperature and is compliant to high-temperature working.

### BACKGROUND ART

Heat-generating parts such as power transistors, CPUs and GPUs lose their performance by their own heat release. In installing these heat-generating parts, a countermeasure of mounting heat sinks thereto for heat dissipation is often taken in the prior art. An epoxy resin-based lid seal material is used to bond a heat sink to a substrate whereas a silicone resin-based heat dissipating material is interposed between the heat sink and the heat-generating part for dissipating the heat therefrom.

In general, silicone resins loaded with highly heat conductive inorganic fillers are used because silicone resins alone fail to provide sufficient heat dissipation. For example, Patent Document 1 proposes a heat-conductive silicone resin filled with aluminum oxide. Patent Document 2 discloses a heat-conductive silicone grease filled with metal aluminum.

As the performance of heat-generating parts is improved, the heat release therefrom is increasing. This invites a tendency that heat sinks become large and complex in shape. Such large heat sinks need more heat-dissipating material, and a greater quantity of heat (temperature×time) is required to cure the material.

Meanwhile, the aforementioned compositions are designed to cure by treatment at a temperature of at most 150° C. When it is desired to cure the composition at high temperature in the process of mounting a large-area heat sink, there arises the problem that the composition cures prior to full wet-spreading.

Therefore, it would be desirable to have a heat-conductive silicone resin composition which does not unintentionally cure during semiconductor device fabrication process.

### CITATION LIST

Patent Document 1: JP-A 2011-153252 (US 2012/0292558)
Patent Document 2: JP-A 2014-037460

### SUMMARY OF INVENTION

An object of the invention is to provide a heat-conductive silicone resin composition which does not unintentionally cure during mounting of heat sinks at high temperature and a curing method thereof.

The inventor has found that a heat-conductive silicone resin composition comprising (A) an organopolysiloxane containing at least two alkenyl groups per molecule, (B) an organohydrogenpolysiloxane having at least two silicon-bonded hydrogen atoms per molecule, (C) a heat-conductive filler, (D) a platinum group metal based catalyst, and (E) a thiol or sulfide group-containing organic compound is effective when the composition has a cure onset time at 150° C. of from 10 minutes to less than 30 minutes, as measured by a scanning vibrating needle curemeter. In the process of applying the composition to an IC chip and mounting it on a heat sink at high temperature, the composition wet-spreads fully to fill in between the IC chip and the heat sink. Because of excellent adhesion and heat conduction, the composition is advantageously used as a heat-dissipating material for electronic parts.

In one aspect, the invention provides a heat-conductive silicone resin composition comprising:

(A) an organopolysiloxane containing at least two alkenyl groups per molecule,

(B) an organohydrogenpolysiloxane having at least two silicon-bonded hydrogen atoms (i.e., SiH groups) per molecule, in an amount to give 0.1 to 4.0 equivalents of SiH groups per equivalent of alkenyl groups in component (A),

(C) a heat-conductive filler,

(D) a platinum group metal based catalyst, and

(E) an organic compound having a thiol or sulfide group,

the composition having a cure onset time at 150° C. of from 10 minutes to less than 30 minutes, as measured by a scanning vibrating needle curemeter.

Preferably, component (E) is compounded in an amount of 80 to 120 parts by weight per part by weight of the platinum group metal in component (D). Also preferably, component (C) is present in an amount of 70 to 95% by weight based on the total weight of components (A) to (E).

In another aspect, the invention provides a method for curing the composition defined above, comprising the step of curing the composition at a temperature of at least 180° C.

### Advantageous Effects of Invention

The heat-conductive silicone resin composition comprising an amount of a thiol or sulfide group-containing organic compound is effective for substantially suppressing unintended thickening or curing during the semiconductor device fabrication process and even at a high temperature of at least 150° C. while it is still curable in the desired shape.

### DESCRIPTION OF PREFERRED EMBODIMENTS

In the disclosure, the singular forms “a”, “an” and “the” include plural referents unless the context clearly dictates otherwise. As used herein, the notation (Cn-Cm) means a group containing from n to m carbon atoms per group. The abbreviation “ppm” stands for parts by weight per million parts by weight.

In one aspect, the invention provides a heat-conductive silicone resin composition comprising (A) an organopolysiloxane containing at least two alkenyl groups per molecule, (B) an organohydrogenpolysiloxane having at least two silicon-bonded hydrogen atoms per molecule, (C) a heat-conductive filler, (D) a platinum group metal based catalyst, and (E) an organic compound having a thiol or sulfide group. The composition has a cure onset time at 150° C. of from 10 minutes to less than 30 minutes, as measured by a scanning vibrating needle curemeter. This design prevents the silicone resin composition from curing during the process of mounting a heat sink at high temperature.

Components (A) to (E) are described below in detail.

### Component (A)

Component (A), which is used as the base polymer in the composition, is an organopolysiloxane containing at least two alkenyl groups per molecule. The organopolysiloxane as (A) is generally a linear one having a backbone composed mainly of repeating diorganosiloxane units and capped at both ends with a triorganosiloxy group although it may contain a branched structure in part of the molecule or be a cyclic one as the overall molecule. Inter alia, a linear diorganopolysiloxane is preferred as component (A) from the aspect of physical properties such as mechanical strength of the cured composition. While component (A) should contain at least two alkenyl groups per molecule, the alkenyl groups may be attached to only the ends of the molecular chain, or at least two ends of the molecular chain and a midway position(s) of the molecular chain. It is preferred that the alkenyl groups be attached to two ends of the molecular chain.

Typical of component (A) are diorganopolysiloxanes having the general formula (1).

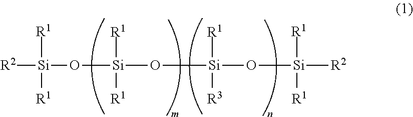

Herein R¹ is each independently a substituted or unsubstituted monovalent hydrocarbon group free of aliphatic unsaturation. R² is each independently a C₂-C₈ alkenyl group or C₃-C₈ cycloalkenyl group. R³ is a group of R¹ or R², and m and n are each independently an integer of at least 0, satisfying 10≦m+n≦10,000 and 0≦n/(m+n)≦0.2.

In formula (1), examples of R¹ include alkyl groups such as methyl, ethyl, propyl, isopropyl, butyl, isobutyl, tert-butyl, pentyl, neopentyl, hexyl, heptyl, octyl, nonyl, decyl and dodecyl; cycloalkyl groups such as cyclopentyl, cyclohexyl and cycloheptyl; aryl groups such as phenyl, tolyl, xylyl, naphthyl and biphenylyl; aralkyl groups such as benzyl, phenylethyl, phenylpropyl and methylbenzyl; and substituted forms of the foregoing in which at least one carbon-bonded hydrogen atom is substituted by a halogen atom (e.g., fluorine, chlorine or bromine), cyano or the like, for example, halo- and cyano-substituted alkyl groups and halo-substituted aryl groups such as chloromethyl, 2-bromoethyl, 3-chloropropyl, 3,3,3-trifluoropropyl, chlorophenyl, fluorophenyl, cyanoethyl and 3,3,4,4,5,5,6,6,6-nonafluorohexyl. R¹ is preferably a hydrocarbon group having 1 to 10 carbon atoms, more preferably 1 to 6 carbon atoms. Even more preferably R¹ is selected from substituted or unsubstituted C₁-C₃ alkyl groups such as methyl, ethyl, propyl, chloromethyl, bromoethyl, 3,3,3-trifluoropropyl and cyanoethyl, and substituted or unsubstituted phenyl groups such as phenyl, chlorophenyl and fluorophenyl. Inter alia, methyl is most preferred.

In formula (1), examples of R² include C₂-C₈ alkenyl groups such as vinyl, allyl, propenyl, isopropenyl, butenyl and hexenyl and C₃-C₈ cycloalkenyl groups such as cyclohexenyl, with vinyl and allyl being preferred.

In formula (1), examples of R³ are as illustrated for R¹ and R². Inter alia, C₁-C₆ hydrocarbon groups are preferred, with C₁-C₃ alkyl, C₂-C₃ alkenyl and phenyl groups being more preferred.

In formula (1), m is an integer of at least 0 and n is an integer of at least 0, satisfying 10≦m+n≦10,000 and 0≦n/(m+n)≦0.2, preferably 50≦m+n≦2,000 and 0≦n/(m+n)≦0.05.

Component (A) preferably has a viscosity at 23° C. in a range of 100 to 100,000 mPa·s, more preferably 100 to 1,000 mPa·s. A viscosity within the range ensures that the resulting silicone resin composition is easy to handle. Notably, the viscosity is measured at 23° C. according to the method described in JIS K7117-1: 1999.

### Component (B)

Component (B), which is a curing agent, is an organohydrogenpolysiloxane having at least two, preferably at least three silicon-bonded hydrogen atoms (i.e., SiH groups) per molecule. It is present in an amount to give 0.1 to 4.0 equivalents, preferably 1.0 to 3.0 equivalents of SiH groups per equivalent of alkenyl groups in component (A). Component (B) may have a linear, branched, cyclic or three-dimensional network structure.

Typical of component (B) are organohydrogenpolysiloxanes having the general formula (2).

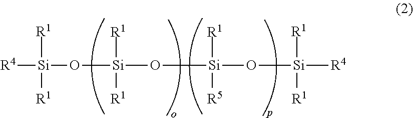

Herein R¹ is as defined above. R⁴ and R⁵ are each independently hydrogen or R¹ and at least two R⁴ are hydrogen. The subscripts o and p are each independently an integer of at least 0, satisfying 1≦o+p≦100.

Examples of the organohydrogenpolysiloxane include siloxane oligomers such as 1,1,3,3-tetramethyldisiloxane, 1,3,5,7-tetramethyltetracyclosiloxane and 1,3,5,7,8-pentamethylpentacyclosiloxane; polysiloxanes such as

trimethylsiloxy-endcapped methylhydrogenpolysiloxane,
trimethylsiloxy-endcapped dimethylsiloxane/methylhydrogensiloxane copolymers,
silanol-endcapped methylhydrogenpolysiloxane,
silanol-endcapped dimethylsiloxane/methylhydrogensiloxane copolymers,
dimethylhydrogensiloxy-endcapped dimethylpolysiloxane,
dimethylhydrogensiloxy-endcapped methylhydrogenpolysiloxane,
dimethylhydrogensiloxy-endcapped dimethylsiloxane/methylhydrogensiloxane copolymers,
trimethylsiloxy-endcapped dimethylsiloxane/diphenylsiloxane/methylhydrogensiloxane copolymers and
dimethylhydrogensiloxy-endcapped dimethylsiloxane/diphenylsiloxane/methylhydrogensiloxane copolymers;
silicone resins comprising R¹₂(H)SiO_{1/2} units and SiO_{4/2} units, optionally R¹₃SiO_{1/2} units, R¹₂SiO_{2/2} units, R¹(H)SiO_{2/2} units, HSiO_{3/2} units or R¹SiO_{3/2} units, wherein R¹ is as defined above. It is noted that the term “endcapped” means that a siloxane is capped at both ends of the molecular chain with the referenced groups, unless otherwise stated.

### Component (C)

Component (C) is a heat-conductive filler for imparting high thermal conductivity to the cured resin composition. The heat conductive filler, preferably has a thermal conductivity of at least 0.4 W/m·K, more preferably at least 4 W/m·K. Examples include ceramic fillers such as alumina powder, boron nitride powder, aluminum nitride powder and silicon nitride powder; and metal powders such as aluminum powder, copper powder and nickel powder.

Component (C) is preferably used in a (total) amount of 70 to 95% by weight based on the total weight of components (A) to (E) in the resin composition. Differently stated, component (C) is preferably used in a fraction of at least 60% by volume based on the total volume (100% by volume) of the composition.

### Component (D)

Component (D) is a platinum group metal based catalyst for promoting addition reaction (i.e., hydrosilylation) of alkenyl groups in component (A) with SiH groups in component (B). It may be any of well-known catalysts for hydrosilylation reaction. Examples of the catalyst include platinum group metals alone such as platinum (including platinum black), rhodium and palladium; platinum chlorides, chloroplatinic acids and chloroplatinates such as H₂PtCl₄.nH₂O, H₂PtCl₆.nH₂O, NaHPtCl₆.nH₂O, KHPtCl₆.nH₂O, Na₂PtCl₆.nH₂O, K₂PtCl₄.nH₂O, PtCl₄.nH₂O, PtCl₂ and Na₂HPtCl₄.nH₂O, wherein n is an integer of 0 to 6, preferably 0 or 6; alcohol-modified chloroplatinic acids (see U.S. Pat. No. 3,220,972); chloroplatinic acid-olefin complexes (see U.S. Pat. No. 3,159,601, U.S. Pat. No. 3,159,662 and U.S. Pat. No. 3,775,452); supported catalysts comprising platinum group metals such as platinum black and palladium on supports of alumina, silica and carbon; rhodium-olefin complexes; chlorotris(triphenylphosphine)rhodium (known as Wilkinson's catalyst); and complexes of platinum chlorides, chloroplatinic acids and chloroplatinates with vinyl-containing siloxanes, specifically vinyl-containing cyclosiloxanes.

Component (D) may be used in a catalytic amount, which is specifically about 0.1 to about 1,000 ppm, more specifically about 0.5 to about 500 ppm of platinum group metal based on the total weight of components (A) and (B).

### Component (E)

Component (E) is an organic compound having a thiol or sulfide group. It is a reaction inhibitor against hydrosilylation, i.e., curing reaction of the resin composition. Component (E), when added in a specific amount, is effective for suppressing unintended thickening or curing of the composition during the semiconductor device fabrication process even at a high temperature of at least 150° C., but still allows the composition to cure in the desired shape. Examples include thiol or sulfide group-containing organosilicon compounds such as 3-mercaptopropyltrimethoxysilane and 3-mercaptopropyldimethoxysilane, thiol or sulfide group-containing aromatic compounds such as 4-bromothiophenol and 2-mercaptobenzoxazole, dimethyl sulfide, disulfides such as diphenyl disulfide, and tetrasulfides such as dipentamethylenethiuram tetrasulfide and bis(triethoxysilylpropyl)tetrasulfide. Inter alia, thiol group-containing organosilicon compounds are preferred.

The amount of component (E) compounded is preferably in a range of 70 to 140 parts by weight, more preferably 80 to 120 parts by weight per part by weight of the platinum group metal in component (D). As long as the amount of component (E) is within the range, the composition is curable in the desired shape even at a high temperature of at least 150° C.

### Optional Components

If necessary, the resin composition may contain an adhesive aid for imparting adhesion. Examples of the adhesive aid include linear or cyclic organosiloxane oligomers of about 4 to 50 silicon atoms, preferably about 4 to 20 silicon atoms and having per molecule at least two, preferably two or three functionalities selected from silicon-bonded hydrogen atoms (i.e., SiH groups), silicon-bonded alkenyl groups such as Si—CH═CH₂ group, alkoxysilyl groups such as trimethoxysilyl, and epoxy groups such as glycidoxypropyl and 3,4-epoxycyclohexylethyl; organoxysilyl-modified isocyanurate compounds and/or hydrolytic condensates thereof such as organosiloxane-modified isocyanurate compounds.

The adhesive aid is preferably added in an amount of 0.1 to 5 parts by weight, more preferably 0.1 to 1 part by weight per 100 parts by weight of component (A).

Also a silane coupling agent different from component (E) and the adhesive aid may optionally be compounded as a diluent for the purpose of adjusting the viscosity of the resin composition. Suitable silane coupling agents include compounds of the general formula (3):

R⁶Si(OR⁷)₃ (3)

wherein R⁶ is a C₁-C₁₀ aliphatic alkyl group and R⁷ is methyl or ethyl.

Besides the adhesive aid and the silane coupling agent, zinc oxide or the like may be compounded as an adhesion improver in the resin composition, if desired.

### Method for Curing Resin Composition

The resin composition may be prepared by mixing the above components until uniform by a well-known technique. The resulting composition may be cured by heating. The cure onset time at 150° C. of the resin composition should preferably range from 10 minutes to less than 30 minutes, more preferably from 10 minutes to 15 minutes, as measured by a scanning vibrating needle curemeter. Such a curing behavior may be effectively established using the specific amount of component (E).

The measurement conditions of a scanning vibrating needle curemeter are set as follows.
Dwell: 100 ms
Frequency filter: 50 Hz
Amplitude filter: 250
Resonance frequency: 81 Hz

As used herein, the term “cure onset time” refers to the time required until the frequency increases 0.2% from the initial frequency during measurement. A cure onset time of shorter than 10 minutes is undesired because it suggests unintentional thickening or curing during working. A cure onset time of 30 minutes or longer is undesired because the overall semiconductor device fabrication time becomes longer, resulting in a decline of productivity. A cure onset time within the range ensures curing of the resin in the desired shape and prevents the step from becoming unnecessarily redundant.

The curing conditions for the resin composition are not particularly limited as long as the composition cures to a full extent. The curing temperature is typically at least 180° C., preferably from 180° C. to 230° C., more preferably from 180° C. to 200° C. The curing time is preferably 1 to 10 hours, more preferably 2 to 6 hours. The curing temperature may be kept constant or increased stepwise until cure is completed. The thus cured product preferably has a thermal conductivity of at least 2 W/m·K.

### EXAMPLE

Examples of the invention are given below by way of illustration and not by way of limitation. The viscosity is measured at 23° C. by a digital viscometer DV-II+Pro (Brookfield Inc.) according to the method described in JIS K7117-1: 1999.

### Preparation Example

A base resin was prepared by mixing 1 kg of dimethylvinylsiloxy-endcapped polydimethylsiloxane having a viscosity of 1,000 mPa·s as component (A), 8 kg of alumina powder AO-41R (Admatechs Co., Ltd.) as component (C), and 1 kg of zinc oxide (Mitsui Mining & Smelting Co., Ltd.) on a planetary mixer.

### Examples 1 to 3 and Comparative Examples 1 and 2

A silicone resin composition was prepared by mixing the base resin in Preparation Example, a methylhydrogenpolysiloxane of the following formula (4) as component (B), a platinum-vinylsiloxane complex (platinum concentration 1 wt %) as component (D), 3-mercaptopropyltrimethoxysilane as component (E), and 2,4,6,8-tetramethyl-2-[3-(oxiranylmethoxy)propyl]cyclotetrasiloxane as adhesive aid in the formulation shown in Table 1.

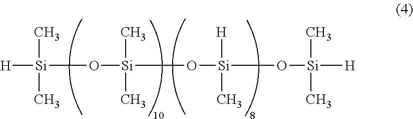

### Example 4

A silicone resin composition was prepared by the same procedure as in Example 1 except that dimethyl sulfide was used as component (E).

### Comparative Example 3

A silicone resin composition was prepared by the same procedure as in Example 1 except that ethynylcyclohexanol was used as component (E).

### Cure Rate Measurement

For seven silicone resin compositions of Examples 1 to 4 and Comparative Examples 1 to 3, a cure onset time at 150° C. was measured by a scanning vibrating needle curemeter (Smithers Rapra Technology Ltd.). The results are also shown in Table 1.

The scanning vibrating needle curemeter was operated under the following measurement conditions.
Dwell: 100 ms
Frequency filter: 50 Hz
Amplitude filter: 250
Resonance frequency: 81 Hz

The time required until the frequency increases 0.2% from the initial frequency during measurement is defined as “cure onset time.”

TABLE 1

| | | | | | Comparative | | |
|---|---|---|---|---|---|---|---|
| | Example | | | | Example | | |
| | 1 | 2 | 3 | 4 | 1 | 2 | 3 |
| Base resin (component | 1,000 | | | | | | |
| (A) + (C)), g | | | | | | | |
| Component (B), g | 2.4 | | | | | | |
| Component (D), g | 0.6 (Pt 0.006) | | | | | | |
| Component (E), g | 0.6 | 0.5 | 0.7 | 0.6 | 0.3 | 1.0 | 0.6 |
| Adhesive aid, g | 0.5 | | | | | | |
| Cure onset time, min | 12 | 10 | 15 | 13 | 5 | 30 | 0.2 |

As seen from Table 1, Examples 1 to 4 using 3-mercaptopropyltrimethoxysilane or dimethyl sulfide as reaction inhibitor (E) are successful in delaying the cure onset time at 150° C. and controlling the cure onset time to the desired value by adjusting the amount of inhibitor added.

In Comparative Example 1, the cure onset time at 150° C. is too short and an ample working time is not available. In Comparative Example 2, the cure onset time at 150° C. is too long, indicating poor working efficiency. In Comparative Example 3 using ethynylcyclohexanol as reaction inhibitor, the cure onset time at 150° C. is extremely short and any working time is unavailable.

Japanese Patent Application No. 2016-159492 is incorporated herein by reference.

Although some preferred embodiments have been described, many modifications and variations may be made thereto in light of the above teachings. It is therefore to be understood that the invention may be practiced otherwise than as specifically described without departing from the scope of the appended claims.

1. A heat-conductive silicone resin composition comprising:
(A) an organopolysiloxane containing at least two alkenyl groups per molecule,
(B) an organohydrogenpolysiloxane having at least two silicon-bonded hydrogen atoms (i.e., SiH groups) per molecule, in an amount to give 0.1 to 4.0 equivalents of SiH groups per equivalent of alkenyl groups in component (A),
(C) a heat-conductive filler,
(D) a platinum group metal based catalyst, and
(E) an organic compound having a thiol or sulfide group,
the composition having a cure onset time at 150° C. of from 10 minutes to less than 30 minutes, as measured by a scanning vibrating needle curemeter.

2. The composition of claim 1 wherein component (E) is compounded in an amount of 80 to 120 parts by weight per part by weight of the platinum group metal in component (D).

3. The composition of claim 1 wherein component (C) is present in an amount of 70 to 95% by weight based on the total weight of components (A) to (E).

4. A method for curing the composition of claim 1, comprising the step of curing the composition at a temperature of at least 180° C.
